(19) United States
(12) Patent Application Publication
(10) Pub. No.: US 2026/0345433 A1
(43) Pub. Date: Nov. 5, 2026

(54) CONTROLLED VIBRATORY SEATING PLATFORM WITH NEUROLOGICAL FREQUENCY ENTRAINMENT

(71) Applicants: SCOTT MATTHEW GAMM, DECORAH, IA (US); HEATHER JO GAMM, DECORAH, IA (US)

(72) Inventors: SCOTT MATTHEW GAMM, DECORAH, IA (US); HEATHER JO GAMM, DECORAH, IA (US)

(21) Appl. No.: 19/666,043

(22) Filed: May 1, 2026

Related U.S. Application Data
(60) Provisional application No. 63/799,653, filed on May 4, 2025.

(51) Int. Cl. A61H 23/02

(52) U.S. Cl. CPC A61H 23/02; A61H 2201/5005

(57) ABSTRACT

A vibratory seating system comprises a body support structure, at least one independently addressable vibration actuator disposed at a predetermined spatial coordinate within the body support structure, a protocol library storing vibration protocol definitions each specifying an operating frequency corresponding to a neurological entrainment frequency associated with a target neurological state, and a processor configured to execute selected protocol definitions to deliver somatic vibratory stimulation to an occupant at the neurological entrainment frequency, producing a frequency-following response tending toward the target neurological state. Target neurological states include delta (0.5-4 Hz), theta (4-8 Hz), alpha (8-12 Hz), beta (12-30 Hz), gamma (30-100 Hz), and high-frequency somatic stimulation (100-250 Hz).

### PRIORITY CLAIM

This application claims the benefit of priority under 35 U.S.C. § 119(e) of U.S. Provisional Patent Application No. 63/799,653, filed May 4, 2025, the entire disclosure of which is incorporated herein by reference.

### FIELD OF THE INVENTION

The present invention relates generally to vibration-based therapeutic and wellness systems, and more particularly to seating platforms employing a spatially distributed array of independently addressable vibration actuators activated in a timed sequential manner to produce directional vibratory propagation through a body support structure, with frequency protocols mapped to target neurological brainwave states to induce frequency-following responses in an occupant.

### BACKGROUND OF THE INVENTION

Vibration-based stimulation of the human body has been studied and applied therapeutically for decades. Three distinct technology lineages are relevant to understanding the present invention: (1) haptic and vibrating seating systems; (2) massage chair systems with sequential zone actuation; and (3) vibroacoustic therapy (VAT) systems that deliver low-frequency vibration through furniture-form body supports.

Vibrating seat systems have been developed primarily for vehicle applications and entertainment. Examples include seats that deliver alert-inducing vibration to drivers (U.S. Pat. No. 5,542,741), and theater seats synchronized to audio and video content (US 2016/0278530—Vibrating Seat). These systems generally employ one or a small number of vibration motors or transducers and deliver uniform or audio-correlated stimulation without spatial coordination or neurological targeting.

Massage chair systems have advanced to incorporate multiple independently operable actuators arranged along anatomical zones of the back, shoulder, lumbar, and seat regions. One example includes a “Person support apparatus” (U.S. Pat. No. 9,827,156) that incorporates programmable sequences of actuator activation. While systems like these may address multiple body zones independently, their actuation logic is organized around anatomical therapeutic targets, replicating massage strokes, rather than around spatial propagation timing designed to produce directed wave effects. To date, the prior art does not disclose inter-actuator delay intervals in the millisecond range for the purpose of creating directional wave propagation.

Vibroacoustic therapy (VAT) is a modality developed beginning in the 1980s in which low-frequency sound vibration is delivered through body-contact surfaces; e.g., mattresses, chairs, cushions, and therapeutic platforms, to produce physiological and neurological effects. Foundational VAT research employed a single loudspeaker in a closed enclosure acoustically coupled to the body through an upholstered support surface, operating in the 30 to 120 Hz range. Subsequent VAT apparatus patents disclose delivery through chair and cushion form factors, chairs with integrated transducers converting audio signals to body-felt vibration, and programmable VAT systems with selectable frequency protocols.

Several VAT references expressly target neurological outcomes. US20070093732A1 discloses frequency sweeps and therapeutic protocols targeting neurological and psychological states including relaxation and anxiety reduction, establishing the connection between somatic vibration at neurological frequencies and brainwave-level effects. US20200138199A1 discloses programmable control of vibroacoustic stimulation through furniture-form body supports with frequency-selectable therapeutic protocols, representing the most technologically advanced VAT system in the prior art.

Despite the above-described developments, the prior art is consistently and uniformly deficient in three structural respects. First, no prior art reference discloses a seating system in which individual vibration actuators are independently addressable at predetermined spatial coordinates within the body support structure. Prior art systems either employ a single transducer or employ multiple transducers that operate simultaneously or independently for massage purposes, but not in a spatially coordinated sequential manner. Second, no prior art reference discloses inter-actuator delay intervals in the range of 20 to 150 milliseconds between successive actuator activations for the purpose of controlling the spatial propagation of vibration. Third, no prior art reference produces directional vibratory propagation, the perception by an occupant of vibration traveling through the seating structure from one spatial region toward another. This combination of spatial addressability, millisecond-precision sequential timing, and resulting directional wave propagation represents a genuinely new architectural approach to somatic vibratory stimulation.

Furthermore, while VAT systems have addressed neurological outcomes at the outcome level, no prior art reference combines neurological frequency targeting with the directional propagation architecture described above. The novel structural mechanism of the present invention, coordinated millisecond-scale sequential activation of spatially arrayed independently addressable actuators, produces a qualitatively different somatic experience than existing VAT systems, one that may more effectively induce frequency-following responses in the somatosensory cortex.

There exists, therefore, a need in the art for a vibratory seating system that employs independently addressable actuators at defined spatial positions, that activates those actuators in a timed sequence with millisecond-precision inter-actuator delays, that produces directional vibratory propagation through the seating structure, and that implements frequency protocols mapped to target neurological brainwave states. The present invention addresses this need.

### SUMMARY OF THE INVENTION

The present invention provides a controlled vibratory seating platform in which at least one vibration actuator is disposed within a body support structure at a predetermined spatial coordinate, a protocol library stores vibration protocol definitions each specifying an operating frequency corresponding to a neurological entrainment frequency associated with a target neurological state, and a processor executes selected protocol definitions to deliver somatic vibratory stimulation to an occupant at the neurological entrainment frequency, producing a frequency-following response tending toward the target neurological state.

In one aspect, the invention provides a vibratory seating system comprising: a body support structure configured to support an occupant; at least one vibration actuator disposed within the body support structure at a predetermined spatial coordinate, the at least one vibration actuator being independently addressable and operable at a selectable operating frequency; a non-transitory computer-readable medium storing a protocol library comprising one or more vibration protocol definitions, each specifying an operating frequency corresponding to a neurological entrainment frequency associated with a target neurological state selected from a group consisting of a delta state (0.5 to 4 Hz), a theta state (4 to 8 Hz), an alpha state (8 to 12 Hz), a beta state (12 to 30 Hz), a gamma state (30to 100 Hz), and a high-frequency somatic stimulation state (100 to 250 Hz); and a processor configured to execute a selected protocol definition by activating the at least one vibration actuator at the specified operating frequency to deliver somatic vibratory stimulation to the occupant through the body support structure.

In another aspect, the invention provides the system of the foregoing aspect wherein the at least one vibration actuator comprises a plurality of vibration actuators disposed within the body support structure at predetermined spatial coordinates, wherein each protocol definition further specifies an ordered subset of the plurality of vibration actuators and an inter-actuator delay interval of 20 to 150 milliseconds between successive actuator activations, and wherein the processor is configured to execute the selected protocol definition by activating each actuator in the ordered subset at its specified operating frequency after the inter-actuator delay interval following activation of the preceding actuator, thereby producing directional vibratory propagation from a first spatial region of the body support structure toward a second spatial region.

In yet another aspect, the invention provides a method of inducing a target neurological state in an occupant of a seating structure, the method comprising: providing a seating structure comprising a body support structure having a plurality of vibration actuators disposed at predetermined spatial coordinates, each actuator being independently addressable; selecting a protocol definition from a stored protocol library, the protocol definition specifying a neurological entrainment frequency corresponding to the target neurological state and an ordered actuator subset with an inter-actuator delay interval of 20 to 150 milliseconds; executing a temporal activation sequence at the neurological entrainment frequency to produce directional vibratory propagation through the body support structure; and delivering somatic vibratory stimulation at the neurological entrainment frequency to the occupant, wherein the stimulation produces a frequency-following response tending toward the target neurological state.

In a further aspect, the invention provides a biofeedback-adaptive vibratory seating system in which at least one biosensor measures a physiological parameter of the occupant indicative of the occupant's current neurological state, and the processor is further configured to receive biosensor data, compare the measured neurological state to the target neurological state, and adaptively select or modify the vibration protocol to reduce the difference between the measured and target states, thereby providing closed-loop neurological entrainment guidance.

The invention further provides novel lexicographic definitions for the claim terms directional vibratory propagation, target neurological state, neurological entrainment frequency, independently addressable, predetermined spatial coordinates, inter-actuator delay interval, and protocol library, which terms are defined with particularity in the Detailed Description and are intended to control over any ordinary meaning in the construction of the appended Claims.

Additional aspects and features of the invention will be apparent from the Detailed Description and the appended Claims.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a perspective view of the vibratory seating platform (100) according to a preferred embodiment, showing the body support structure (110) and the spatial distribution of independently addressable vibration actuators (120) across the lumbar (122), thoracic (124, 126), cervical (128), and seat pan (132, 134, 136) zones, together with the control system (130) and user interface (140);

FIG. 2 is a top plan view of the backrest (114) and seat pan (112) showing the spatial coordinate grid, the predetermined spatial coordinates of actuators A1 through A12, and the anatomical zone designations with corresponding reference numerals;

FIG. 3 is a cross-sectional elevation view taken along line 3-3 of FIG. 2, showing the layered construction of the body support structure including the structural frame, acoustic isolation layer (144), actuator mounting bracket (142), vibration actuator (120), and upholstery and cushioning layer (146);

FIG. 4 is a block diagram of the control system (130), showing the processor (150), the non-transitory computer-readable medium (152) storing the protocol library (154), the actuator driver array (156), the user interface module (158), and the optional biosensor input module (160);

FIG. 5 is a timing diagram illustrating a representative five-actuator temporal activation sequence for an alpha-band protocol at 10 Hz with inter-actuator delay interval T_delay of 75 milliseconds, showing the sequential activation times of actuators A1 through A5 and the resulting propagation direction;

FIG. 6 is a schematic diagram illustrating directional vibratory propagation produced by sequential activation of actuators A1 through A4 in a lumbar-to-cervical protocol, showing the vibratory field at each actuator position and the direction vector of the resulting propagation wave;

FIG. 7 is the neurological frequency mapping table organizing the protocol library (154) by target brainwave band, showing the frequency ranges, neurological correlates, target actuator operating frequencies, and commercial application verticals for each of the six protocol categories; and

FIG. 8 is a block diagram of the biofeedback-adaptive embodiment, showing the biosensor (162), biosensor input module (160), state comparator, and closed-loop adaptive protocol selection logic within the processor (150).

### DETAILED DESCRIPTION OF THE PREFERRED EMBODIMENTS

The following detailed description is provided to enable any person skilled in the art to make and use the claimed invention, and sets forth the best mode contemplated by the inventor for carrying out the invention. The description is not intended to limit the scope of the claims appended hereto.

As used throughout this specification, the singular forms “a”, “an”, and “the” include plural referents unless the context clearly dictates otherwise. The word “or” as used herein means any one member of a particular list and also includes any combination of members of that list. Conditional language such as “may”, “can”, “might”, or “could” is generally intended to convey that certain embodiments include, while other embodiments do not include, certain features, elements, or steps.

The following definitions are provided to establish the precise meaning of claim terms used in this specification and the appended Claims. These definitions control over any ordinary meaning and shall be incorporated verbatim into the patent specification. “Directional vibratory propagation” means a vibratory stimulation pattern produced by the activation of two or more vibration actuators at different predetermined spatial coordinates within a body support structure in a temporal sequence, wherein each successive actuator in the ordered sequence is activated after an inter-actuator delay interval in the range of 20 to 150 milliseconds following the activation of the preceding actuator, such that the resulting aggregate vibratory stimulus produces, in an occupant in contact with the body support structure, a perceived motion or flow of vibration originating from a first spatial region of the body support structure corresponding to the first actuator in the ordered subset, and progressing toward a second spatial region corresponding to the last actuator in the ordered subset, defining a direction vector from said first spatial region to said second spatial region. “Target neurological state” means a neurological condition characterized by dominant brainwave activity within a specified frequency band as measured by electroencephalographic (EEG) power spectral density analysis, wherein the specified frequency band is selected from the group consisting of: (a) delta, defined as 0.5 to 4 Hz; (b) theta, defined as 4 to 8 Hz; (c) alpha, defined as 8 to 12 Hz; (d) beta, defined as 12 to 30 Hz; and (e) gamma, defined as 30 to 100+ Hz. The term encompasses specific cognitive or physiological states associated with each band, including deep sleep and pain gating (delta), meditative states, creativity, and anxiety reduction (theta), relaxed alertness and stress reduction (alpha), active focus and sustained attention (beta), and high-order cognitive processing and working memory (gamma).

Within the 100 to 250 Hz range, somatic vibratory stimulation acts primarily through Pacinian corpuscles, the fastest and most frequency-sensitive mechanoreceptors in the body, optimally tuned to vibration between approximately 60 and 400 Hz and peaking in sensitivity near 200-250 Hz. Pacinian corpuscles are distributed broadly across deep subcutaneous tissue, fascia, periosteum, and joint capsules, meaning whole-body contact vibration at these frequencies produces widespread mechanoreceptor recruitment across the back, pelvis, and lower extremities simultaneously. This mass recruitment drives high-frequency afferent signaling through large-diameter Aβ nerve fibers into the spinal cord, where it activates gate control inhibitory interneurons in the dorsal horn, the same mechanism underlying TENS and vibratory analgesia, producing measurable reduction in ascending nociceptive (pain) signal transmission.

At these frequencies, vibration also activates Meissner's corpuscles in superficial skin layers (sensitive up to approximately 80-150 Hz) and stimulates muscle spindle Ia afferents, producing the tonic vibration reflex and promoting reflexive muscle relaxation through reciprocal inhibition of antagonist muscle groups. The net peripheral effect is a combination of mechanical deep-tissue stimulation, fascial mobilization through resonance at tissue-specific natural frequencies, and broad-field sensory gating.

The neurological connections from this somatosensory activity are real and measurable, though they operate through different pathways than brainwave entrainment. The dense Aβ afferent barrage generated by Pacinian corpuscle recruitment at 100-250 Hz propagates through the dorsal column-medial lemniscal pathway directly to the primary somatosensory cortex (S1) and secondary somatosensory cortex (S2), producing sustained cortical activation that competes with and suppresses pain-related processing in the anterior cingulate and insula.

Clinically, this maps to documented applications including vibration-induced analgesia, post-operative recovery acceleration, spasticity reduction in neurological rehabilitation, and lymphatic and microcirculatory enhancement through smooth muscle relaxation in vessel walls, all with peer-reviewed support independent of brainwave entrainment theory. Critically, sustained high-frequency somatosensory cortical activation at S1/S2 has been shown to produce secondary modulation of limbic and prefrontal activity through cortico-cortical projections, meaning the downstream neurological benefit, reduced pain perception, lowered autonomic arousal, improved affective state, is legitimate and documentable without invoking the frequency-following response mechanism. This provides the specification with a robust, independently supported scientific rationale for the 100-250 Hz operating range that stands entirely on its own footing. “Neurological entrainment frequency” means a vibration frequency at which a vibration actuator within the claimed system is operated to produce a somatosensory stimulus that, upon transmission through the body support structure to the body of an occupant in contact therewith, is capable of producing a frequency-following response in which the dominant cortical brainwave activity of the occupant tends toward the target neurological state through somatosensory cortical entrainment. The neurological entrainment frequency corresponds to the frequency of the target neurological state's brainwave band: delta protocols operate actuators at 0.5 to 4 Hz, theta protocols at 4 to 8 Hz, alpha protocols at 8 to 12 Hz, beta protocols at 12 to 30 Hz, and gamma protocols at 30 to 100 Hz. “Independently addressable” means capable of receiving and executing an individual activation command specifying at least an activation time and an operating frequency, independently of any simultaneous or sequential activation command issued to any other actuator in the plurality. An independently addressable actuator does not require a shared trigger signal or common activation timing with other actuators in the system. “Predetermined spatial coordinates” means defined positions within a spatial reference frame fixed to the body support structure, specified prior to system operation and stored in the protocol library or system configuration, such that each actuator is associated with a unique coordinate identifier corresponding to its physical location within the body support structure. “Inter-actuator delay interval” means a time duration, measured in milliseconds, between the activation of one vibration actuator in an ordered subset and the activation of the next successive actuator in that ordered subset during the execution of a protocol definition. The inter-actuator delay interval ranges from 20 milliseconds to 150 milliseconds, inclusive. At delay intervals below 20 milliseconds, successive actuator activations are perceived by the somatosensory system as substantially simultaneous and do not produce a discrete directional wave effect. At delay intervals above 150 milliseconds, successive activations are perceived as separate, distinct vibratory events rather than as a continuous directional wave. “Protocol library” means a stored collection of one or more vibration protocol definitions accessible to the processor, wherein each protocol definition specifies at minimum: (a) a protocol identifier; (b) an operating frequency corresponding to a neurological entrainment frequency associated with a target neurological state; and (c) an amplitude level and protocol duration. In embodiments comprising a single vibration actuator, a protocol definition need not specify an ordered actuator subset or inter-actuator delay interval, as the protocol is executed by activating the single actuator at the specified operating frequency for the specified duration. In embodiments comprising a plurality of independently addressable vibration actuators, each protocol definition additionally specifies: (d) an ordered subset of actuators from the plurality, identified by their predetermined spatial coordinates; and (e) an inter-actuator delay interval of 20 to 150 milliseconds between successive actuator activations, the execution of which produces directional vibratory propagation through the body support structure. The protocol library may additionally specify repetition count, loop behavior, and target neurological state label for each protocol definition, and may be organized by target neurological state category to facilitate occupant selection through the user interface. “Frequency-following response” means a neurophysiological phenomenon in which the dominant brainwave frequency of an occupant shifts toward the frequency of a repetitive external stimulus through the mechanism of somatosensory cortical entrainment, supported by the vibroacoustic therapy literature including work by Skille (1989) and Wigram (1996).

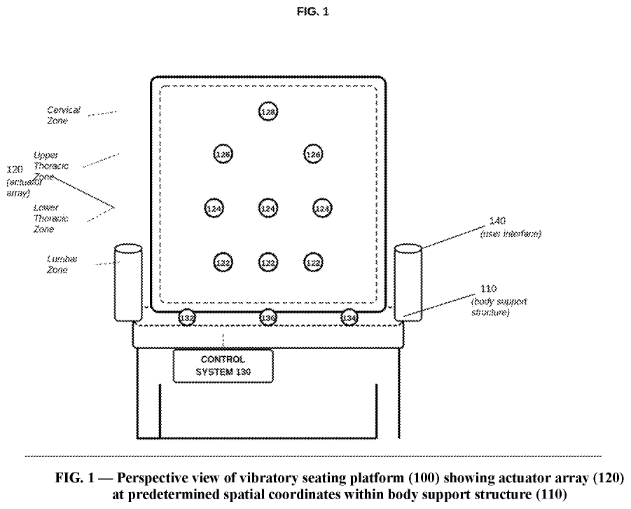

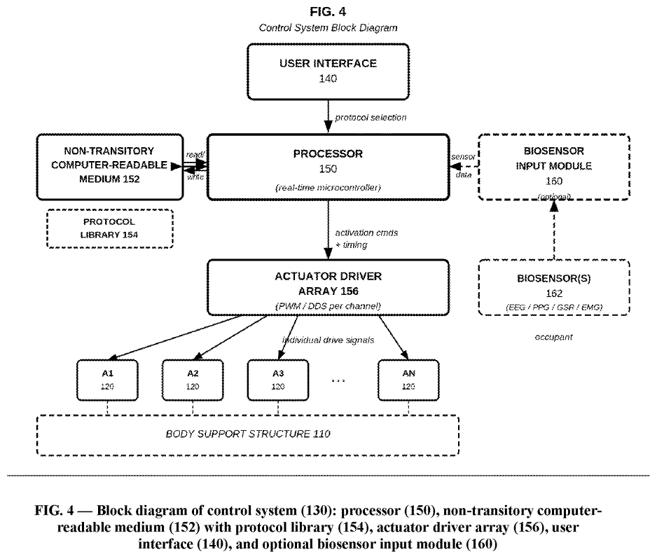

Referring to FIGS. 1 through 3, the vibratory seating platform 100 according to a preferred embodiment of the invention comprises a body support structure 110, a plurality of vibration actuators 120 disposed within the body support structure 110 at predetermined spatial coordinates, a control system 130 (described further below with reference to FIG. 4), and a user interface 140.

The body support structure 110 comprises at least a seat pan portion 112 configured to support the lower body of an occupant, with or without a backrest portion 114 configured to support the torso and upper body of the occupant. In the preferred embodiment, the body support structure 110 further comprises an upper backrest extension 116 supporting the cervical and upper thoracic region. The body support structure 110 may take the form of any seating configuration including a chair, recliner, bench seat, saddle seat, portable seat, lounger, or other seating apparatus.

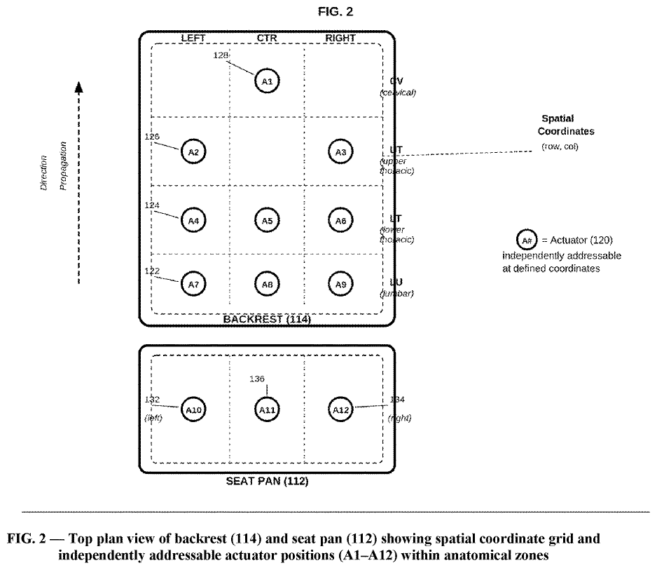

The plurality of vibration actuators 120 are disposed within the body support structure 110 in a distributed spatial array. In the preferred embodiment, the plurality of vibration actuators 120 comprises at least eight (8) individual actuator units distributed across the seat pan portion 112 and the backrest portion 114, arranged within the following anatomical zones: a lumbar zone 122 in the lower backrest corresponding to lumbar vertebral levels L1 through L5; a lower thoracic zone 124; an upper thoracic zone 126; a cervical zone 128; a left seat pan zone 132; a right seat pan zone 134; and a central seat pan zone 136, as shown in FIG. 2.

Each vibration actuator 120 is disposed at a predetermined spatial coordinate within the body support structure 110. The spatial coordinates are defined within a reference frame fixed to the body support structure 110, and each actuator is registered to its coordinate in the protocol library 154. The spatial coordinates may be expressed as a two-dimensional grid (row and column positions) or as named anatomical zone identifiers with defined geometric centroids.

The vibration actuators 120 may be of any type capable of generating controlled vibration at frequencies in the range of 0.5 to 250 Hz, including linear resonant actuators (LRAs), eccentric rotating mass (ERM) motors, piezoelectric actuators, voice coil actuators, or electromagnetic actuators. In the preferred embodiment, linear resonant actuators are employed. Piezoelectric actuators are preferred for gamma-band (30 to 100 Hz) frequencies due to their superior high-frequency response.

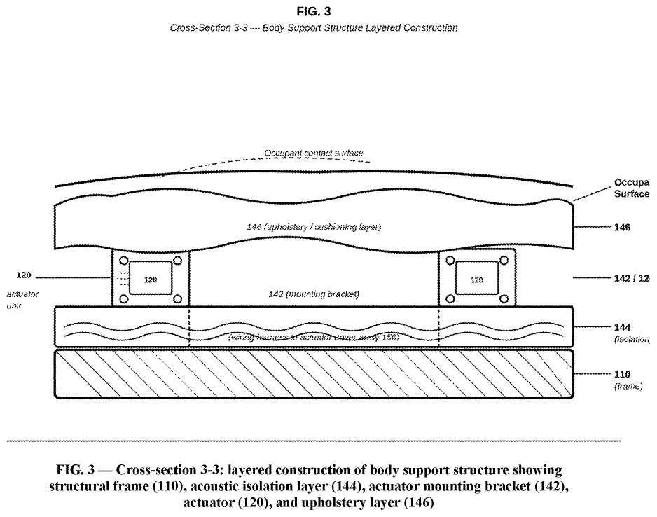

Each vibration actuator 120 is mechanically coupled to the body support structure 110 through actuator mounting brackets 142 secured within the frame, with acoustic isolation layer 144 interposed between the mounting bracket and the structural frame, and upholstery and cushioning layer 146 overlying the actuators, as shown in FIG. 3.

Referring to FIG. 4, the control system 130 comprises a processor 150, a non-transitory computer-readable medium 152 storing the protocol library 154, an actuator driver array 156, a user interface module 158, and an optional biosensor input module 160. The processor 150 is operatively connected to the actuator driver array 156, which provides individually addressable drive signals to each vibration actuator 120.

The processor 150 may be any suitable processing device capable of executing stored instructions with millisecond-precision timing, including microcontrollers, digital signal processors (DSPs), field-programmable gate arrays (FPGAs), or application-specific integrated circuits (ASICs). In the preferred embodiment, a dedicated real-time microcontroller is employed to ensure deterministic timing of actuator activation commands.

The non-transitory computer-readable medium 152 stores the protocol library 154 comprising a plurality of vibration protocol definitions. Each protocol definition specifies: (a) a protocol identifier; (b) an ordered subset of vibration actuators identified by their spatial coordinates; (c) an operating frequency for each actuator; (d) an inter-actuator delay interval T_delay in the range of 20 to 150 milliseconds; (e) an amplitude level; (f) a protocol duration; (g) a repetition count; and (h) an optional target neurological state label.

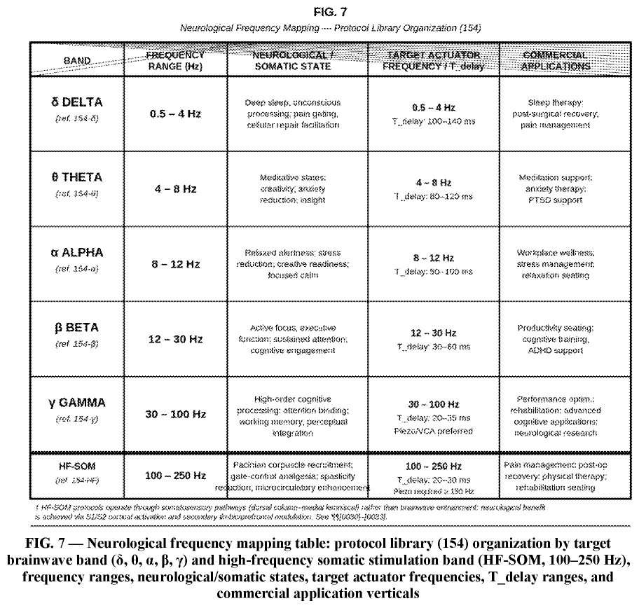

In the preferred embodiment, the protocol library 154 is organized into neurological state categories as illustrated in FIG. 7: delta protocols (0.5 to 4 Hz), theta protocols (4 to 8 Hz), alpha protocols (8 to 12 Hz), beta protocols (12 to 30 Hz), and gamma protocols (30 to 100 Hz), each targeting the corresponding brainwave band through somatic vibratory stimulation at the neurological entrainment frequency.

The actuator driver array 156 comprises individually addressable driver circuits for each vibration actuator 120, each capable of receiving an activation command specifying a frequency, amplitude, and start time, and generating the corresponding drive waveform. In the preferred embodiment, the driver array employs pulse-width modulation (PWM) or direct digital synthesis (DDS) waveform generation.

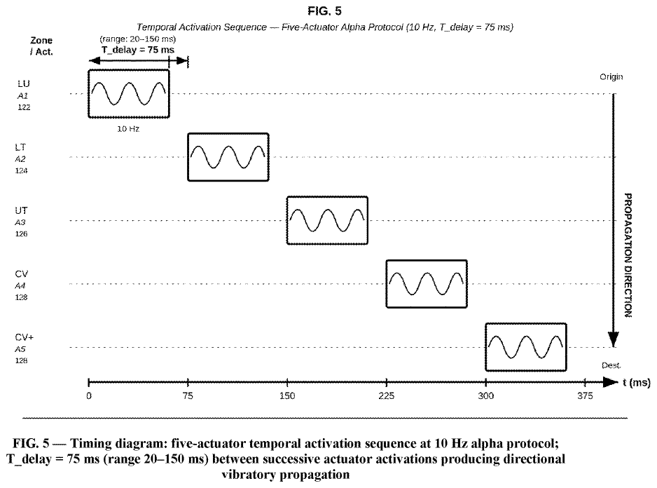

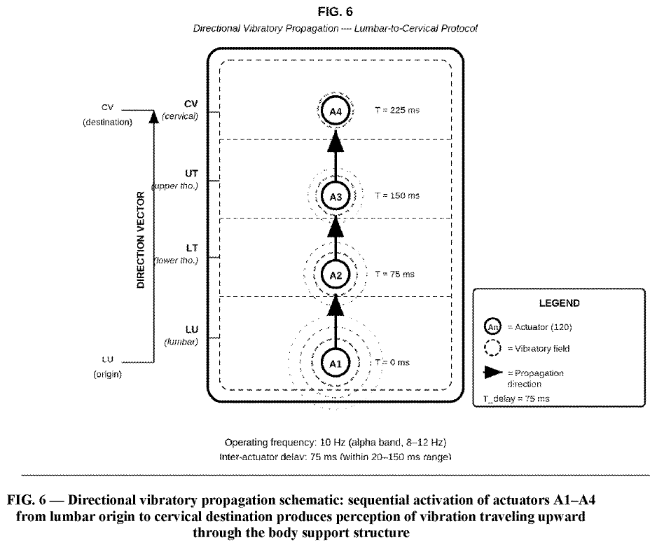

Referring to FIGS. 5 and 6, the processor 150 executes a selected protocol definition by issuing activation commands to the actuator driver array 156 in the order specified by the ordered actuator subset, with an inter-actuator delay interval T_delay between successive commands. At time T=0, the processor activates the first actuator A1 in the ordered subset. At time T=T_delay, the processor activates A2. This repeats for each successive actuator, with the n-th actuator An activated at time T=(n−1)×T_delay.

The inter-actuator delay interval T_delay is set to a value in the range of 20 to 150 milliseconds. At values below approximately 20 milliseconds, successive actuator activations are perceived as substantially simultaneous, producing no directional propagation percept. At values above approximately 150 milliseconds, successive activations are perceived as discrete, separate vibratory events rather than a continuous directional wave. Within the 20 to 150 millisecond range, the temporal integration properties of the somatosensory cortex produce a unified percept of vibration traveling through the seating structure from the first actuator's position toward the last, defining a direction vector from A1 to An.

This directional vibratory propagation is produced by, and depends upon, all three of the following structural elements acting in combination: (1) independently addressable actuators at predetermined spatial coordinates; (2) inter-actuator delay intervals in the 20 to 150 millisecond range; and (3) the temporal activation sequence executed by the processor. All three structural elements are necessary and together sufficient.

The direction of propagation is determined by the ordering of actuators in the protocol definition's ordered subset. A lumbar-to-cervical ordering produces a bottom-to-top propagation wave. Reversing the ordering produces a top-to-bottom wave. The system supports all propagation directions achievable within the spatial array, including diagonal and multi-directional protocols.

In a representative five-actuator alpha-band protocol: actuators A1 (lumbar), A2 (lower thoracic), A3 (upper thoracic), A4 (cervical), A5 (upper cervical) are activated in sequence at a 10 Hz operating frequency with T_delay of 75 milliseconds and a 30-second looping duration, as shown in FIG. 5. The occupant perceives a smooth, upward-traveling wave of 10 Hz vibration ascending continuously from lumbar to cervical, as illustrated in FIG. 6.

The neurological frequency entrainment aspect of the invention operates through the frequency-following response, in which repetitive somatic stimulation at a specified frequency tends to drive dominant cortical brainwave activity toward that frequency through somatosensory cortical entrainment. This mechanism has been documented in the vibroacoustic therapy literature. The present invention applies this mechanism through the directional propagation array, producing a qualitatively different somatic experience that may enhance entrainment efficacy through the additional dimension of spatial propagation cues.

The neurological entrainment protocols are organized by target brainwave band, as illustrated in FIG. 7. For each band, the actuators operate at the corresponding neurological entrainment frequency, producing somatic vibration that tends to drive cortical oscillation toward the target band.

Delta protocols (0.5 to 4 Hz) employ very-low-frequency operation producing deep rhythmic somatic pulses, indicated for sleep induction, deep relaxation, post-surgical recovery support, and pain management.

Theta protocols (4 to 8 Hz) produce rhythmic low-frequency somatic stimulation associated with meditative states, creative flow, and anxiety reduction, indicated for meditation support, anxiety management, and PTSD support.

Alpha protocols (8 to 12 Hz) produce moderate-frequency somatic stimulation associated with relaxed alertness and stress reduction, indicated for workplace wellness seating and relaxation applications.

Beta protocols (12 to 30 Hz) produce higher-frequency somatic stimulation associated with active cognitive engagement, sustained attention, and executive function, indicated for productivity seating and cognitive training.

Gamma protocols (30 to 100 Hz) employ the highest frequencies, associated with high-order cognitive processing and working memory, with piezoelectric or voice coil actuators preferred for their superior frequency response in this range.

High-frequency somatic stimulation (HF-SOM) protocols (100 to 250 Hz) operate above the neurological entrainment range and produce direct mechanoreceptor stimulation of the Pacinian corpuscles described in paragraphs [0031] through [0034], which exhibit peak responsiveness within this frequency band. HF-SOM protocols do not rely upon the frequency-following response but instead produce therapeutic somatic effects through direct deep-tissue mechanoreceptor activation, and are indicated for peripheral circulation enhancement, deep-tissue relaxation, pain-gate modulation, peripheral neuropathy support, and myofascial tension reduction. At HF-SOM frequencies, piezoelectric actuators are preferred over voice coil or ERM motor types due to their superior frequency response above 100 Hz.

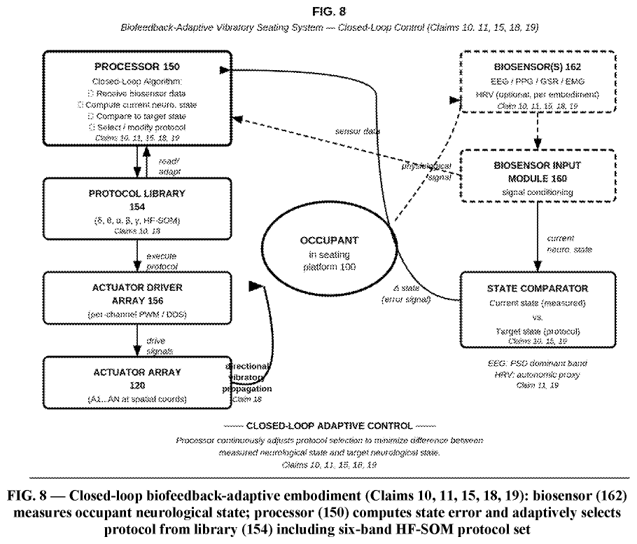

Referring to FIG. 8, in an alternative embodiment, the vibratory seating platform 100 further comprises at least one biosensor 162 operatively connected to the biosensor input module 160. The biosensor 162 is configured to measure at least one physiological parameter of the occupant indicative of the occupant's current neurological state.

Suitable biosensor types include electroencephalographic (EEG) sensors measuring cortical brainwave activity directly, photoplethysmographic (PPG) sensors, galvanic skin response (GSR) sensors, and electromyographic (EMG) sensors. In the preferred biofeedback embodiment, EEG sensors or Heart Rate Variability (HRV) are employed.

The processor 150, operating in biofeedback-adaptive mode, executes a closed-loop control algorithm comprising: (a) receiving biosensor data; (b) computing a measure of the occupant's current neurological state; (c) comparing it to the target neurological state; (d) computing a state difference metric; (e) selecting or modifying a protocol to reduce the deviation; and (f) executing the modified protocol. This process repeats continuously throughout the session.

The biofeedback-adaptive embodiment represents the highest-value claim tier. Closed-loop biosensor-adaptive somatic neurological entrainment through a directional propagation vibratory seating platform is not disclosed in any prior art reference reviewed.

The invention is not limited to chair-form body support structures. Alternative body support embodiments include recliner chairs, office chairs, bed or mattress platforms, therapeutic tables, floor cushion platforms, vehicle seats, and stadium and theater seats modified to include the actuator array and control system of the present invention.

Minimum viable embodiments require at least one independently addressable actuator at distinct spatial coordinates. Of course, more than one actuator is contemplated for all embodiments herein as well. Enhanced embodiments with larger arrays (16, 24, 32, or more actuators) provide finer spatial resolution and support more complex propagation geometries.

The inter-actuator delay interval T_delay need not be uniform. Each actuator-to-actuator transition may specify its own delay interval within the 20 to 150 millisecond range, allowing for non-uniform propagation velocities simulating natural wave dynamics.

The protocol library 154 may be stored as a fixed factory-installed set, a user-configurable set, a network-updated library receiving protocols from a cloud-based server, or any combination thereof.

The user interface 140 may take any suitable form including a physical control panel, a touchscreen display, a companion mobile application communicating via Bluetooth or Wi-Fi, or a voice-controlled interface.

In some embodiments, the protocol library includes protocols combining directional propagation with additional modalities including audio output synchronized to the vibratory propagation wave, localized heat application, Pulse Electromagnetic Frequencies (PEMF) and chromotherapy.

### EXAMPLE I—A Single-Actuator Embodiment

To illustrate the operation of the invention in its broadest embodiment, consider a vibratory seating system 100 comprising a single vibration actuator, actuator A1, disposed at the central lumbar zone position (LU, C) of the backrest portion 114, corresponding approximately to the L3 vertebral level of the occupant's spine. Actuator A1 is a linear resonant actuator (LRA) mounted to actuator mounting bracket 142, mechanically coupled to the structural frame of the body support structure 110 through acoustic isolation layer 144, and separated from the occupant's lumbar contact surface by upholstery and cushioning layer 146, as shown in FIG. 3. The protocol library 154 stored in the non-transitory computer-readable medium 152 comprises a plurality of single-actuator protocol definitions organized by target neurological state, including an alpha-band protocol specifying an operating frequency of 10 Hz, an amplitude of 75% of rated output, a duration of 20 minutes, and a target neurological state of alpha (8 to 12 Hz relaxed alertness). Upon occupant selection of the alpha protocol through user interface 140, the processor 150 issues an activation command to the actuator driver circuit within actuator driver array 156, which generates a sinusoidal drive waveform at 10 Hz and delivers it to actuator A1. Actuator A1 oscillates at 10 Hz, transmitting that oscillation through mounting bracket 142 and upholstery layer 146 to the occupant's lumbar musculature, recruiting Pacinian corpuscles and Meissner's corpuscles within the lumbar soft tissue and delivering somatic vibratory stimulation at the alpha neurological entrainment frequency. The sustained 10 Hz somatic stimulus produces a frequency-following response tending toward the alpha target neurological state through somatosensory cortical entrainment. In this single-actuator embodiment, the vibratory stimulation is localized to the lumbar contact region of the body support structure and does not produce directional vibratory propagation; the therapeutic effect is achieved through sustained neurological entrainment frequency delivery at a single predetermined spatial coordinate. This embodiment represents the minimum viable configuration of the invention and is fully operative to achieve the neurological entrainment objective of the claimed system.

EXAMPLE II-Plurality-of-Actuators Embodiment Via Directional Propagation

To illustrate the operation of the invention in the directional propagation embodiment of Claim 2, consider a vibratory seating system 100 comprising a plurality of twelve (12) vibration actuators A1 through A12 disposed across the backrest portion 114 and seat pan portion 112 at predetermined spatial coordinates, as shown in FIG. 2. In a representative ascending alpha-band protocol, five actuators from the backrest array are designated as the ordered subset: A7 at the central lumbar zone (LU, C), A5 at the central lower thoracic zone (LT, C), A3 at the upper thoracic zone (UT, C), A2 at the upper thoracic left zone (UT, L), and A1 at the cervical zone (CV, C). The protocol definition specifies an operating frequency of 10 Hz for all actuators in the ordered subset, an inter-actuator delay interval T_delay of 75 milliseconds, an amplitude of 75% of rated output, and a protocol duration of 20 minutes with continuous looping. Upon occupant selection of this protocol, the processor 150 executes the temporal activation sequence as follows: at time T=0 ms, actuator A7 is activated at 10 Hz, producing localized lumbar stimulation; at T=75 ms, actuator A5 is activated at 10 Hz, producing lower thoracic stimulation while A7 continues; at T=150 ms, actuator A3 is activated at 10 Hz; at T=225 ms, actuator A2 is activated; and at T=300 ms, actuator A1 is activated at the cervical zone, as illustrated in FIG. 5. The cumulative result of this sequential activation, each actuator separated from the next by 75 milliseconds, well within the 20 to 150 millisecond range that the somatosensory cortex integrates as a continuous unified percept rather than discrete events, is that the occupant perceives a smooth, continuous wave of 10 Hz vibration ascending from the lumbar region toward the cervical region, as illustrated in FIG. 6. This directional vibratory propagation is an emergent property of the ordered sequential activation of the actuator subset as a whole and is not produced by any individual actuator operating alone; it requires the combination of independently addressable actuators at predetermined spatial coordinates, inter-actuator delay intervals within the 20 to 150 millisecond range, and the temporal activation sequence executed by the processor 150. The ascending propagation wave delivers somatic vibratory stimulation at the alpha neurological entrainment frequency of 10 Hz continuously through the full spinal column contact surface of the body support structure, producing a frequency-following response tending toward the alpha target neurological state through somatosensory cortical entrainment enhanced by the spatial propagation cues processed by the somatosensory cortex.

The invention encompasses method embodiments in which a computing system executes protocol execution, protocol selection, or biofeedback-adaptive control steps on behalf of a human user or healthcare professional.

It will be understood by those skilled in the art that the foregoing description is of preferred embodiments of the invention, and that various changes and modifications may be made without departing from the spirit and scope of the invention as set forth in the appended Claims.

Any mention of specific brand names, manufacturers, or model numbers is provided solely for illustrative purposes. Such references are exemplary of the types of components intended to be used in implementing the present invention and are not intended to limit the scope of the invention to any specific brand, model, or manufacturer. Persons of skill in the art will readily recognize that equivalent components, whether now known or later developed, that perform substantially the same function in substantially the same way with substantially the same result are within the scope of this disclosure and the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A vibratory seating system comprising:
i. a body support structure configured to support an occupant;
ii. at least one vibration actuator disposed within said body support structure at a predetermined spatial coordinate, said at least one vibration actuator being independently addressable and operable at a selectable operating frequency;
iii. a non-transitory computer-readable medium storing a protocol library comprising one or more vibration protocol definitions, each protocol definition specifying an operating frequency corresponding to a neurological entrainment frequency associated with a target neurological state, said target neurological state selected from a group consisting of a delta state (0.5 to 4 Hz), a theta state (4 to 8 Hz), an alpha state (8 to 12 Hz), a beta state (12 to 30 Hz), a gamma state (30 to 100 Hz), and a high-frequency somatic stimulation state (100 to 250 Hz); and
iv. a processor configured to execute a selected protocol definition by activating said at least one vibration actuator at said specified operating frequency to deliver somatic vibratory stimulation to said occupant through said body support structure.

2. The vibratory seating system of claim 1, wherein said at least one vibration actuator comprises a plurality of vibration actuators disposed within said body support structure at predetermined spatial coordinates, wherein each vibration actuator is independently addressable, and wherein each protocol definition further specifies an ordered subset of said plurality of vibration actuators and an inter-actuator delay interval ranging from about 20 to about 150 milliseconds between successive actuator activations, and wherein said processor is configured to execute said selected protocol definition by activating each actuator in said ordered subset at its specified operating frequency after said inter-actuator delay interval following activation of said preceding actuator, thereby producing directional vibratory propagation from a first spatial region of said body support structure toward a second spatial region.

3. The vibratory seating system of claim 2, wherein said plurality of vibration actuators comprises at least two actuators distributed across a seat pan portion with or without a backrest portion of said body support structure.

4. The vibratory seating system of claim 2, wherein said plurality of vibration actuators are disposed in at least three of said following anatomical zones: a lumbar zone, a lower thoracic zone, an upper thoracic zone, a cervical zone, a left seat pan zone, a right seat pan zone, and a central seat pan zone.

5. The vibratory seating system of claim 2, wherein said vibration actuators comprise linear resonant actuators, piezoelectric actuators, voice coil actuators, or eccentric rotating mass motors, or any combination thereof.

6. The vibratory seating system of claim 2, wherein said protocol library further organizes protocol definitions by target neurological state, and wherein said operating frequency of each protocol definition corresponds to a neurological entrainment frequency within a brainwave band associated with said target neurological state, said brainwave band selected from: delta (0.5 to 4 Hz), theta (4 to 8 Hz), alpha (8 to 12 Hz), beta (12 to 30Hz), gamma (30 to 100 Hz), and combinations thereof.

7. The vibratory seating system of claim 2, wherein said inter-actuator delay interval is independently configurable for each successive actuator pair in said ordered subset.

8. The vibratory seating system of claim 2, wherein said processor is further configured to execute protocol definitions with opposing propagation directions, including at least one ascending protocol in which said direction vector extends from a lower body zone toward an upper body zone, and at least one descending protocol in which said direction vector extends from an upper body zone toward a lower body zone.

9. The vibratory seating system of claim 2, further comprising a user interface operatively connected to said processor and configured to present said protocol library to said occupant organized by target neurological state and to receive a protocol selection from said occupant.

10. The vibratory seating system of claim 2, wherein said body support structure is selected from said group consisting of: a chair, a recliner, a lounger, a vehicle seat, a therapeutic table, a floor cushion platform, a portable seat and a bed mattress platform.

11. The vibratory seating system of claim 2, further comprising:
i. at least one biosensor configured to measure a physiological parameter of said
occupant indicative of said occupant's current neurological state; and
ii. wherein said processor is further configured to:
a. receive biosensor data from said at least one biosensor;
b. compute a measure of said occupant's current neurological state from said biosensor data;
c. compare said measured current neurological state to a target neurological state associated with said selected protocol definition; and
d. adaptively select or modify said protocol definition based on said comparison to reduce said difference between said measured current neurological state and said target neurological state.

12. The vibratory seating system of claim 11, wherein said at least one biosensor comprises an electroencephalographic (EEG) sensor, a photoplethysmographic (PPG) sensor, a galvanic skin response (GSR) sensor, an electromyographic (EMG) sensor, heart rate variability (HRV), or any combination thereof.

13. A method of inducing a target neurological state in an occupant of a seating structure,
said method comprising:
i. providing a seating structure comprising a body support structure having a plurality
of vibration actuators disposed at predetermined spatial coordinates, each actuator being independently addressable;
ii. storing a protocol library comprising vibration protocol definitions, each specifying an ordered subset of said plurality of vibration actuators, a neurological entrainment frequency corresponding to said target neurological state, and an inter-actuator delay interval of 20 to 150 milliseconds;
iii. selecting a protocol definition from said protocol library corresponding to said target neurological state;
iv. executing, by a processor, a temporal activation sequence at said neurological entrainment frequency by activating each actuator in said ordered subset after said inter-actuator delay interval following activation of said preceding actuator, thereby producing directional vibratory propagation through said body support structure;
and v. delivering somatic vibratory stimulation at said neurological entrainment frequency
to said occupant through said body support structure, wherein said stimulation produces a frequency-following response in said occupant tending toward said target neurological state.

14. The method of claim 13, wherein said target neurological state is selected from said group consisting of: a delta state characterized by dominant brainwave activity at 0.5 to 4 Hz; a theta state characterized by dominant brainwave activity at 4 to 8 Hz; an alpha state characterized by dominant brainwave activity at 8 to 12 Hz; a beta state characterized by dominant brainwave activity at 12 to 30 Hz; and a gamma state characterized by dominant brainwave activity at 30 to 100 Hz.

15. The method of claim 13, wherein said directional vibratory propagation proceeds from a lower body zone of said body support structure toward an upper body zone, or from an upper body zone toward a lower body zone, or in a diagonal direction across said body support structure, as determined by said ordering of actuators in said ordered subset.

16. The method of claim 13, further comprising:
i. measuring, by at least one biosensor, a physiological parameter of said occupant
indicative of said occupant's current neurological state;
ii. comparing said measured current neurological state to said target neurological state; and
iii. adaptively modifying said selected protocol definition based on said comparison to reduce said difference between said current neurological state and said target neurological state.

17. The method of claim 13, wherein executing said temporal activation sequence comprises executing protocol definitions with opposing propagation directions in alternating sequence, thereby producing a rhythmically oscillating directional wave effect in said occupant.

18. A biofeedback-adaptive vibratory seating system comprising:
i. a body support structure configured to support an occupant;
ii. a plurality of vibration actuators disposed within said body support structure at predetermined spatial coordinates, wherein each vibration actuator is independently addressable;
iii. a non-transitory computer-readable medium storing a protocol library comprising vibration protocol definitions, each specifying an ordered subset of actuators, a neurological entrainment frequency, and an inter-actuator delay interval of from about 20 to about 150 milliseconds;
iv. at least one biosensor configured to measure a physiological parameter of said occupant indicative of said occupant's current neurological state;
v. a processor configured to:
a. execute a temporal activation sequence by activating actuators in said ordered subset at said neurological entrainment frequency with said inter-actuator delay interval, thereby producing directional vibratory propagation through said body support structure;
b. receive biosensor data from said at least one biosensor; and
c. adaptively select or modify protocol definitions from said protocol library based on said biosensor data to guide said occupant's neurological state toward a target neurological state.

19. The biofeedback-adaptive vibratory seating system of claim 18, wherein said at least one biosensor comprises an electroencephalographic (EEG) sensor, heart rate variability (HRV) and wherein said processor computes EEG power spectral density from said sensor data and compares said dominant brainwave frequency band to said target neurological state to determine said adaptive protocol selection.
